(19) United States
(12) Patent Application Publication
(10) Pub. No.: US 2017/0130879 A1
(43) Pub. Date: May 11, 2017

(54) Pipe Coupling Having Arcuate Snap Couplers With Cylindrical Base Body

(71) Applicant: Ajit Singh Gill, Salt Lake City, UT (US)

(72) Inventor: Ajit Singh Gill, Salt Lake City, UT (US)

(21) Appl. No.: 15/235,980

(22) Filed: Oct. 26, 2016

Related U.S. Application Data
(60) Provisional application No. 62/205,454, filed on Aug. 14, 2015.

(51) Int. Cl. F16L 23/00; F16L 23/16

(52) U.S. Cl. CPC F16L 23/003; F16L 23/16

(57) ABSTRACT

A coupler for coupling together the end portions of two pipes includes a single piece cylindrical base body having a receiving opening therethrough to receive and surround end portions of the pipes to be coupled and bridging over a gap between the pipes to be coupled. The cylindrical base body has a plurality of truncated flanges on each of opposite end portions thereof with aligned openings extending through truncated flanges on opposite ends of the cylindrical base body. At least one arcuate coupler having a first hinge extending from a first end and a second hinge extending from a second end is secured around the cylindrical base body by a first fastener bolt passing through the first hinge and aligned openings and by a second fastener bolt passing through the second hinge and aligned openings.

### FIELD

The invention is in the field of pipe couplings to connect two pipes, two hoses and valves to pipes.

### STATE OF THE ART

Inventor holds U.S. Pat. No. 8,474,880 B2 which shows an arcuate snap coupler joining two unfixed separable face to face flanges where one of the hinges of the snap coupler is positioned between the face to face flanges pivotally attached an end of the coupler to a fastener bolt which extends between the face to face flanges and through the hinge. Said two flanges are separated by removable partitioner situated in the interior inside of the coupling body. The arcuate snap coupler is rotated about the hinged end to move the opposite end toward the pipe end portions to capture portions of the flanges within arcuate snap coupler face to face flanges. Invented couplers are fixed between two face to face truncated mini flanges constructed at opposite ends of the cylindrical tube and couplers need no to be separated ever from said cylindrical tube. The invented coupling has distinct advantage for making flange to flange versatile connections.

### SUMMARY OF INVENTION

According to the invention, a pipe coupler, hereinafter referred to as an arcuate snap couplers, which are pivotally attached to a cylindrical base (made from tube) by means of hinges and fasteners, where hinges extend between face to face radial mini truncated flanges formed directly on the opposite ends of the cylindrical tube, and fasteners are bolts with nuts; and bolt heads and nuts remain outside of the mini flanges. Fasteners of invented coupler also can be ball joints. Both ends of each arcuate coupler are pre-attached to the cylindrical base of the coupling body by means of said fasteners. Preferably a vise or semi-vise is provided between said fasteners, which vise is made of a bolt and one or two vise nuts. Preferably for most of the applications only one vise nut will be used with the invented Coupling. To connect two pipes, Preferably, first one end of each arcuate coupler is freed from the fastener and each arcuate coupler is rotated away from the cylindrical base of the coupling, then one receiving end of the cylindrical base of the coupling body is mounted around the end of one pipe and that end of the coupling is attached to the end of the first pipe by means of said vise. Then, the end of the second pipe is pushed into the second receiving end of the coupling and the arcuate snap couplers are rotated radially one after another toward the pipe to capture simultaneously opposite ends of pipes to be connected. Said ends of pipes are specially designed flanges (rings) which are welded or kept free around the ends of said pipes or they are welded at the ends of the pipes which will become apparent under description of drawings. In another alternative, arcuate coupler can be uplifted vertically up ward away from its base to free the opposite flanges it is connecting. From here on flanges means, flanges means to connect or disconnect two pipes or two hoses or pipe with the valve.

### DRAWINGS

The best mode presently contemplated for carrying out he invention is illustrated in the accompanying drawings, in which:

FIG. 1 is the perspective view of the cylindrical base of the coupling body having face to face mini truncated flanges at its opposite ends, and depicting face to face opposite openings for the fasteners;

FIG. 2 is a perspective view of typical arcuate coupler, where two hinges are depicted at the opposite ends of the coupler and two opposite inner radial flanges also are depicted;

FIG. 3 is the perspective view of two opposite rings which can be welded to the ends of two opposite ends of pipes or around the end portions of the of two opposite pipes;

FIG. 4 is the traverse longitudinal vertical section of the coupling body, depicting opposite rings which can be welded to the ends (or around the end portions) of their respective pipes, and are attached together by means of the couplers of the invented coupling;

FIG. 5 is a right side longitudinal perspective view of the of the coupling body where one end is shown without fasteners;

FIG. 6 is a frontal perspective view of the coupling shown in FIG. 1 and fasteners with threads are shown;

FIG. 7 is a left side longitudinal view of the coupling body where two arcuate couplers are partially opened by rotating them about their fasteners, which fasteners are positioned through opposite face to face openings provided through the mini truncated opposite face to face flanges;

FIG. 8 is the perspective view of the coupling where the arcuate length of inner radial flanges 5 and 6 is reduced and optional cap is shown around mini;

FIG. 9 is the perspective view of the coupler depicting means to pull away the coupler by its end from its connection with the coupling base body and optional rubber or elastomeric cap is provided to protect means of connections between mini flanges;

FIG. 10 is the traverse longitudinal vertical section of a coupling to connect two opposite plain ends of pipes with the invented coupling.

### DETAILED DESCRIPTION OF THE ILLUSTRATED EMBODIMENT

Drawings are not drawn to any particular Scale. As the same coupler is repeated on both sides of the coupling, and the same conical section to connect plain end pipe is repeated on both sides of the coupling, therefore, they are mostly assigned the same numbers on both sides of the coupling. To depict other body parts of the coupling, numbers of right side elements corresponding with the left side elements are assigned numbers appended with a letters in ascending order. Thus, when one side element is being explained, the corresponding element on opposite side of the coupling body will be considered explained simultaneously too. Perspective views of parts and assemblies depict the invention clearly, therefore only needed hidden lines are shown in drawings. Bolts for vise and for fasteners passing through mini flanges B1 and B2 will be considered bolts of the first set, and bolts for vise and fasteners passing through mini flanges B3 and B4 will be considered as bolts of the second set. First set of bolts is the same as in the second set.

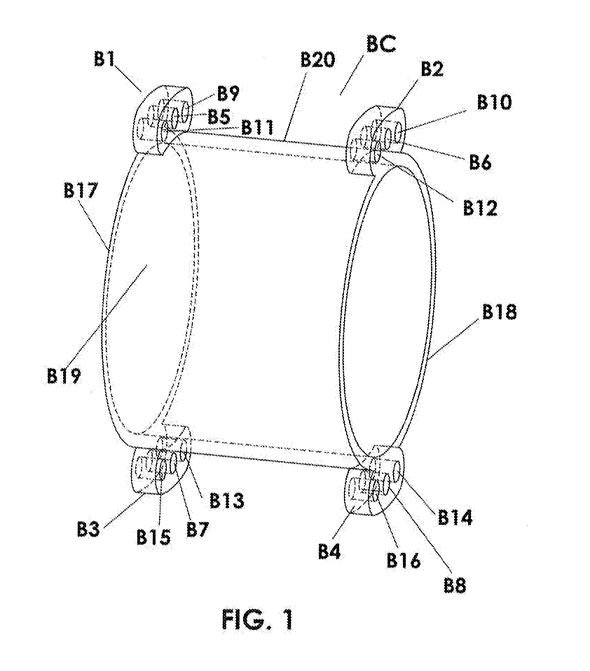

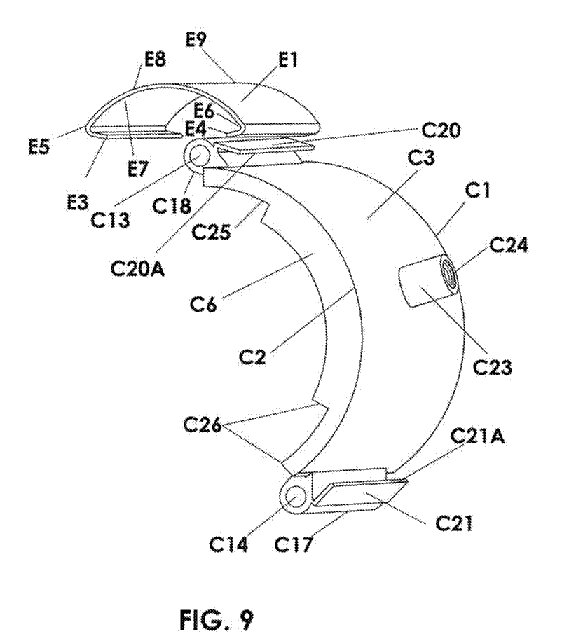

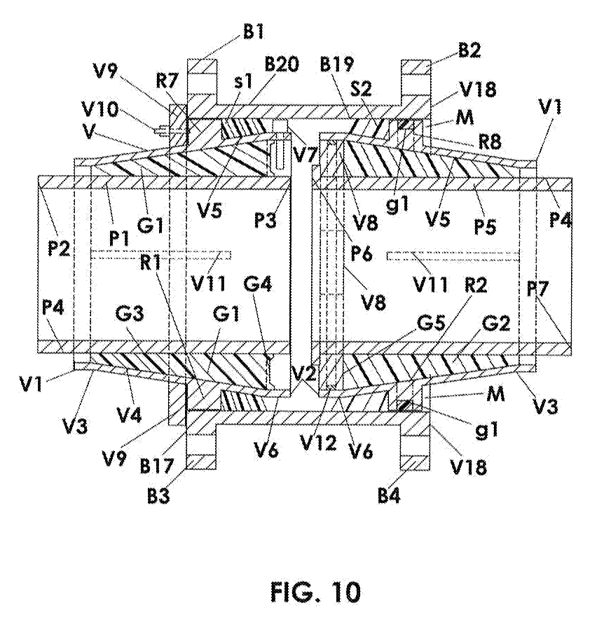

FIGS. 1 to 9 can be studied simultaneously. FIG. 10 differs only for the means to connect the plain end Pipe

Drawings show only two couplers mounted around the cylindrical base for the couplers, but it will be understood that more than two couplers can be used for large size pipe or only a single coupler may be used for small size pipe with very low pressure.

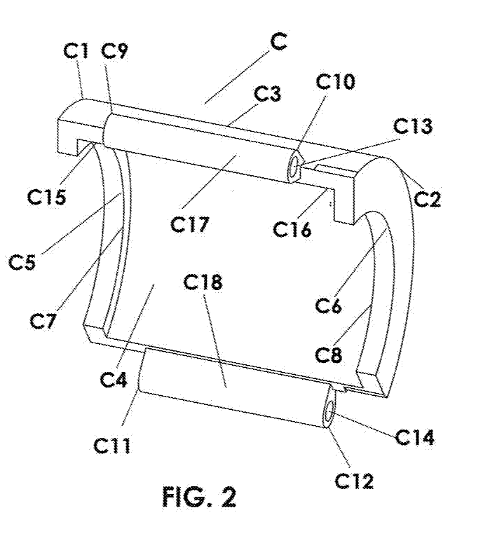

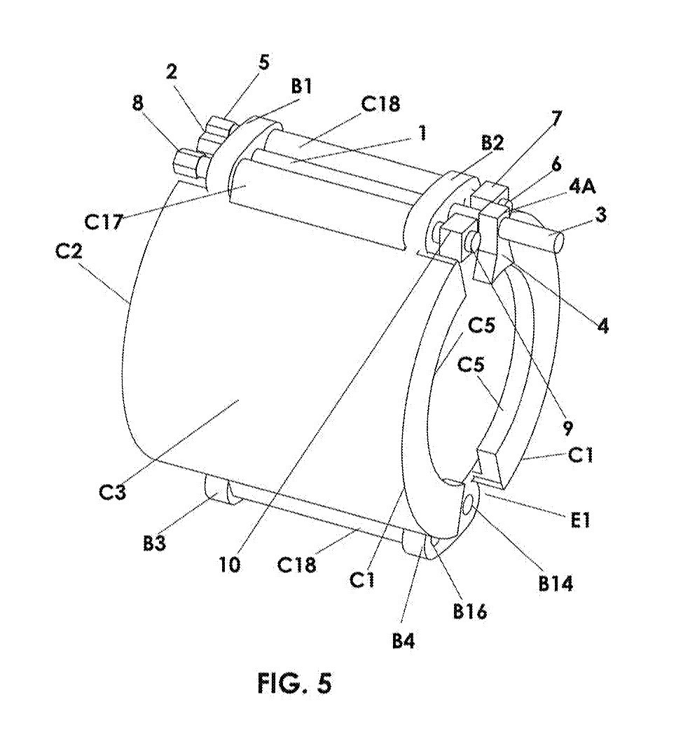

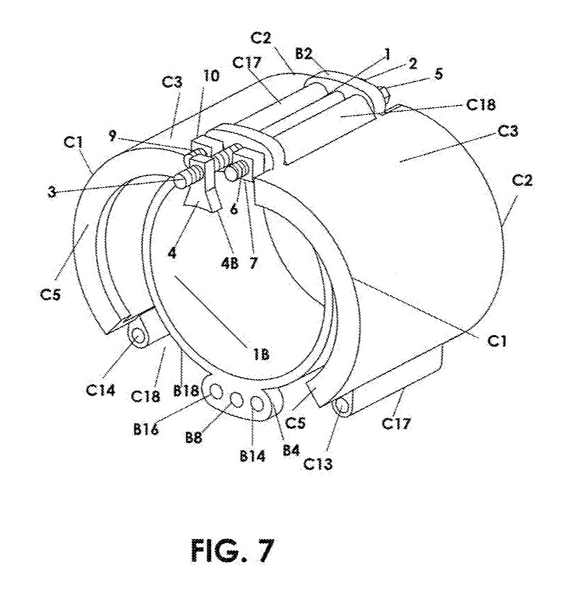

FIG. 1 shows the cylindrical base B20 of the coupling body has mini opposite face to face truncated flanges B1, B2; B3, B4 constructed at its opposite ends B17 and B18, between which the hinges C17 and C18 of coupler C depicted in FIG. 2 are kept rotatable and fixed in positions till needed to be rotated. Each coupler is considered as 180 degree rotated from the position of opposite coupler. Thus same numbers are shown in position of the coupler. Shown in Openings B5, B6 and B7 and B8 are provide for bolt vise which will be explained later. Shown in FIGS. 5 to 7, hinges C17 and C18 are attached by means of bolt fastener 5 and 8 between truncated mini flanges B1 and B2; and mini flanges B3 and B4. Shown in FIG. 1, openings B13, B14; B15 and B16 are provided for same bolt fasteners as mentioned above (fasteners are not shown) to hold hinges C17 and C18 shown in FIG. 7. Shown in FIG. 5, hinge C18 is attached to the coupling by passing stem of bolt fastener 5 through the openings B9 in mini flange B1, and opening B10 in mini flange B2. Bolt is shown by its head 5 and its stern 6 and it held in place by tightening nut 7 against mini flange B2. Similarly hinge C17 is attached to coupling by means of bolt fastener 9 and nut 10 by tightening of nut 10 against B2. It is pointed out here again that same sizes of bolts are used through mini flanges B3 and b4.

It should be noticed that for clarity of drawings in FIGS. 1, and 1A and 1B only one (first) hinge of each coupler is shown being pivotally attached to the coupling body between mini flanges B1 and B2, while second hinge of each coupler is shown in free states, and no fasteners similar to the above mentioned fasteners for the second hinge are shown.

Coupler shown in FIG. 2 is shown in different mounted positions around the coupling body in FIGS. 5 to 7. The coupler C has outer surface C3 and inner surface C4, and it is provided opposite arcuate inner vertical radial flanges C5 and C6 having differential radii. The inner faces of C5 and C6 are indicated by C7 and C8. The length of hinges C17 and C18 between mini flanges B1 and B2; and mini flanges B3 and B4 are depicted by C9 and C10, and C11 and C12 respectively. Distance between C9 and C7 is indicated by C15; and distance between C10 and C8 is indicated by C16. The width of the coupler C is shown between C1 and C2.

opposite face to face openings B5, B6; and B7 and B8 are provided in mini flanges B1, B2 and B3 an B4 respectively for vise made of bolt 2 and threaded stem 3 and vise nut 4. Nut 4 has narrower top flange 4A than the wider bottom flange 4B shown in FIGS. 5 to 7. Only one vise nut is shown in the drawings. In some application the use of two vise nuts one nut 4 on each side of the coupling will be used. If nut 4 is not provided threads then a long nut made from a tube with one end closed will be used. The vise nut 4 next to the bolt head 2 may not be provided threads.

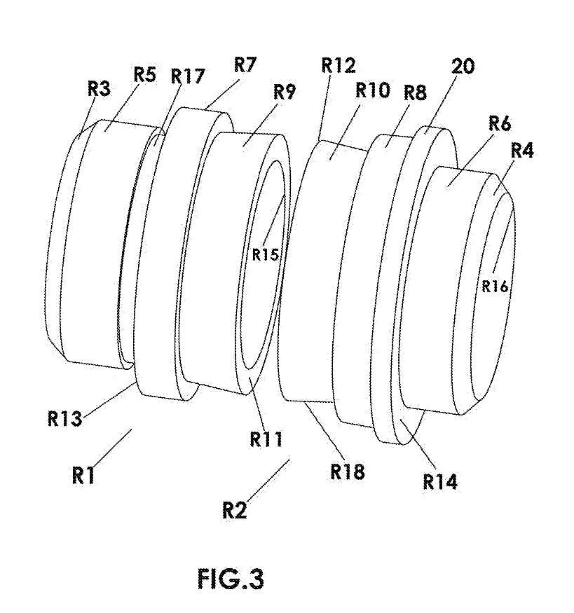

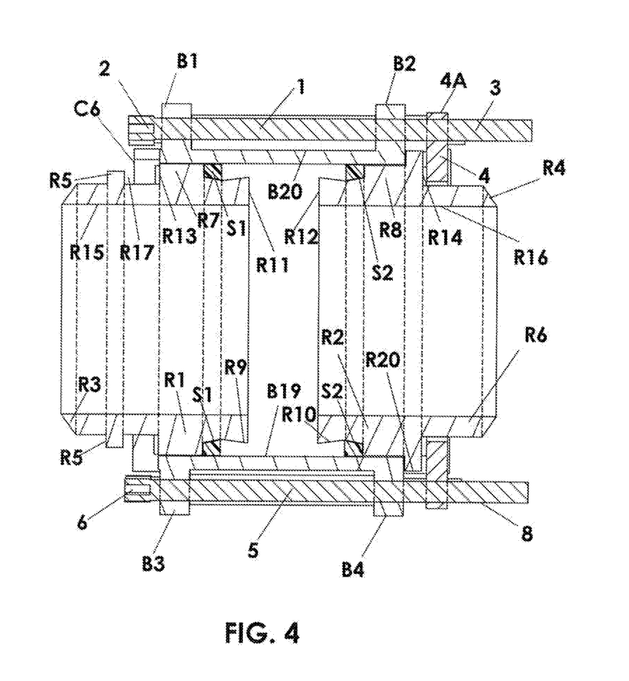

FIGS. 3 and 4 show two rings R1 and R2 which can be welded around the end portions of two opposite ends of pipes or they can be welded to the ends of said two opposite ends of pipes by their ends R3 and R4.

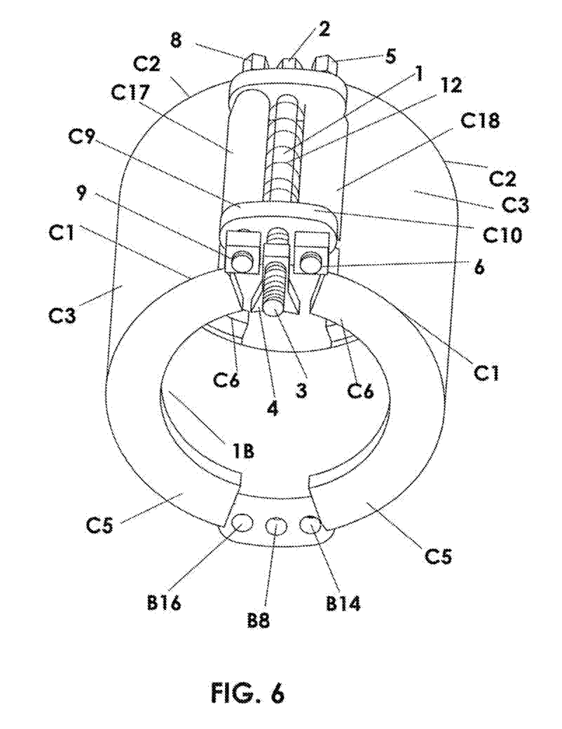

FIGS. 5 to 7 should be studied together. As shown in FIG. 7 first hinges C17 and C18 between mini flanges B3 and B4 of the coupling body are freed from their bolt fasteners 5 and 8 of second set, which pass passing through openings B13 and B14; and openings B15 and B16 in B3 and B4 and the couplers C3 are opened by rotating them about the hinges C17 and C18 between mini flanges B1 and B2 all the way so that the end B18 of the coupling with mini flanges B2 and B4 can be mounted around radial portion R8 of ring R2 (of the first pipe) till it is stopped by the radial flange R20 as shown in FIG. 4. Then vise nut 4 around stem 3 of bolt 1 tightened against radial wall R14 of ring R2. And similarly vise nut 4 around stem 8 of bolt 5 tightened. Bolts 1 and 5 are shown in FIG. 4. Thus first, end B18 of coupling is secured to ring R2. Then ring R1 of second pipe is pushed into B19 the inside of coupling body BC till radial wall R13 of radial portion R7 of ring R1 matches with end B17 of coupling body BC. Then each arcuate coupler is rotated about the hinged end to move the opposite end toward the rings R1 and R2 to capture opposite radial walls R13 and R14 of rings R1 and R2 within an arcuate coupler channel and to position the circular hinge at the opposite end of the arcuate coupler between the face to face mini flanges B3 and B4 constructed at the opposite ends of the coupling body as shown in FIG. 6. Then with the second set of bolts hinges B17 and B18 are secured to the mini flanges B3 and B4.

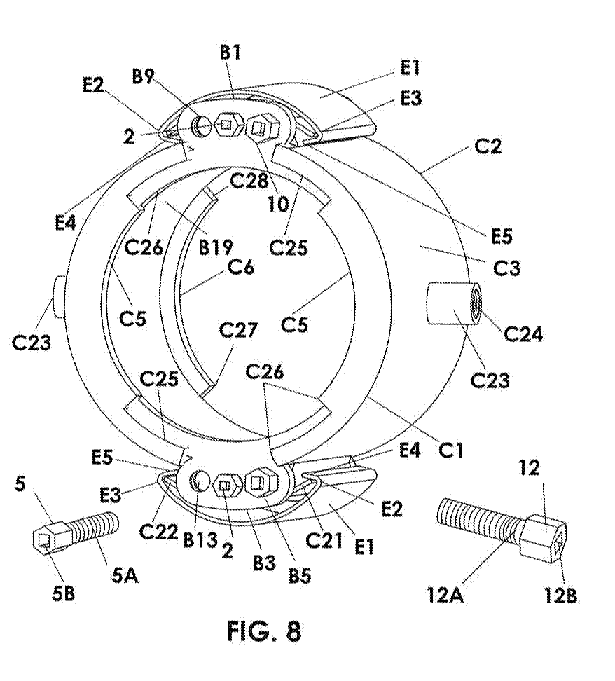

FIG. 8 is the perspective view of the coupling where the arcuate length of inner radial flanges 5 and 6 is reduced. When the pressure in the pipe is not high and space is narrow to rotate the couplers all the way the length of cuts C25 and C26 is reduced. Threaded socket C23 with threads C24 is provide for large pipe to ease disconnecting of one end of the coupling by rotating it about the other end. Threaded Stem 12A of bolt 12 is driven into threaded opening C24 to produce a lever handle. The wrench is applied to socket hole 12B to tight the bolt. Optional rubber of elastomeric cap E1 to protect said means between mini flanges is shown with it ends E2 and E3.

is the perspective view of the coupler C3 depicting means; a socket C23 with thread C24 is to pry away C18 or C17 whatever the case may be by means of a bolt bar made of a bolt which was discussed earlier. Other optional means to pry away C18 and C17 are shown by welded plates C20 and C21 with lengths C20A and C21A. An optional rubber or elastomeric cap E1 discussed is provided protect said means of connections between mini flanges.

FIG. 10 is the traverse longitudinal vertical section of a coupling to connect two opposite plain ends of pipes P1 and pipe P5 with the invented coupling. Coupling is provided inner means to connect plain, which are similar to certain extent with my U.S. Pat. Nos. 7,455,331 B2 and 8,474,880 B2. The main means constitute truncated conical sections V and V1 which mirror each other. Elastomeric griping plugs G1 and G2 grip against outer surfaces P4 of the two pipes and seal gaskets are shown by S1 and S2 which prevent leakage of fluid between the inner means and B19 of the coupling body. Inner surface of V and V1 are indicated by V5. Two methods are presented to prevent the slipping away of the elastomeric plugs G1 and G2 from the pipes. Plug G1 is prevented from slipping away with the aid of bolts V7, and G2 is prevented to slip away by means of radial rings V8 and Flange P6. Outer portions of plugs G1 and G2 are provided cuts shown by V11 for the ease of mounting the plugs around the pipes P1 and P5. Radial flange rings R1 and R2 are provided for the stability of the coupling and to connect the coupling with R1 and R2. R1 and R2 may be kept free by providing separable flange V9 mounted around bolts V10, Constituting V9 and R7 as single part. Rings R1 and R2 may be provided gasket g1 in a radial groove as shown with R2. For clarity of movement M flange V9 and bolt V10 are not shown with R2. The Pipe ends are depicted by P2, p3; P7 and P6 as radial flange. Desirable separation between two pipes is indicated by V2. All other part of the coupling body were discussed earlier. No couplers are shown in FIG. 10 which were discussed with other FIGS.

1. A coupler for coupling together the end portions of two pipes, comprising:
a single piece cylindrical base body having a receiving opening therethroughto receive and surround end portions of the pipes to be coupled and bridging over a gap between the pipes to be coupled, said cylindrical base body having a plurality of truncated flanges on each of opposite end portions of the cylindrical base body, each of said truncated flanges having an opening extending therethrough with said opening through a truncated flange on one end portion of the cylindrical base body being aligned with said opening through a truncated flange on the opposite end portion of the cylindrical base body;
a plurality of fastener bolts adapted to extend between aligned openings through said plurality of truncated flanges on each of opposite end portions of the cylindrical base body;
at least one arcuate coupler having opposite ends with a first hinge extending from a first of said opposite ends of the arcuate coupler and with a second hinge extending from a second of said opposite ends of the arcuate coupler, said first and second hinges sized to fit between truncated flanges on each of opposite end portions of the cylindrical base body, said first hinge adapted to pivotally mount the at least one arcuate coupler to one fastener bolt of the plurality of fastener bolts and said second hinge adapted to secure the at least one arcuate coupler to another fastener bolt of the plurality of fastener bolts and to hold the at least one arcuate coupler in a rotated position to secure the end portions of the pipes to be connected to the single piece cylindrical base body in connected condition.

2. A coupler for coupling together the end portions of two pipes according to claim 1, wherein each hinge at the first and second end of the at least one arcuate coupler is a cylindrical tube through which a fastener bolt extends.

3. A coupler for coupling together the end portions of two pipes according to claim 1, wherein the arcuate coupler includes opposite end walls forming inwardly extending radial end flanges joined by a channel web between said opposite end flanges.

4. A coupler for coupling together the end portions of two pipes according to claim 3, wherein the cylindrical base body is received within the arcuate coupler between the opposite end flanges and wherein receiving recesses are formed between the opposite ends of the cylindrical base body and the opposite end flanges.
